(19) United States
(12) Patent Application Publication
(10) Pub. No.: US 2009/0027200 A1
(43) Pub. Date: Jan. 29, 2009

(54) Electronic Wireless Detecting and Alarm Device Allowing Monitoring Of Fluid Level in a Tank or Cistern

(76) Inventors: Tanguy Herbert, Hirel (FR); Dominique Josselin, St Aubin du Cormier (FR)

Correspondence Address: GEORGE A. SEABY;SEABY & ASSOCIATES, 250 CITY CENTRE AVNUE, OTTAWA, ON, K1R6K7, CA

(21) Appl. No.: 12/223,962

(22) PCT Filed: Feb. 16, 2007
(86) PCT No.: PCT/FR2007/000280

§ 371 Date: Aug. 14, 2008

(30) Foreign Application Priority Data
Feb. 17, 2006 (FR) 06/01391

(51) Int. Cl. G08B 13/14

(52) U.S. Cl. 340/568.1; 340/612

(57) ABSTRACT

The invention concerns an electronic device for monitoring a reservoir (14) or a tank. The invention consists of two electronic elements, module (13) and module (15). Module (13) controls the reservoir using a telemetric measurement (1) and reports to module (15) via a radio link (3 and 5). By analyzing the data emitted by the monitoring module (13), the control module (15) enables an alarm (9 and 10) to be activated or not to indicate a current break-in.

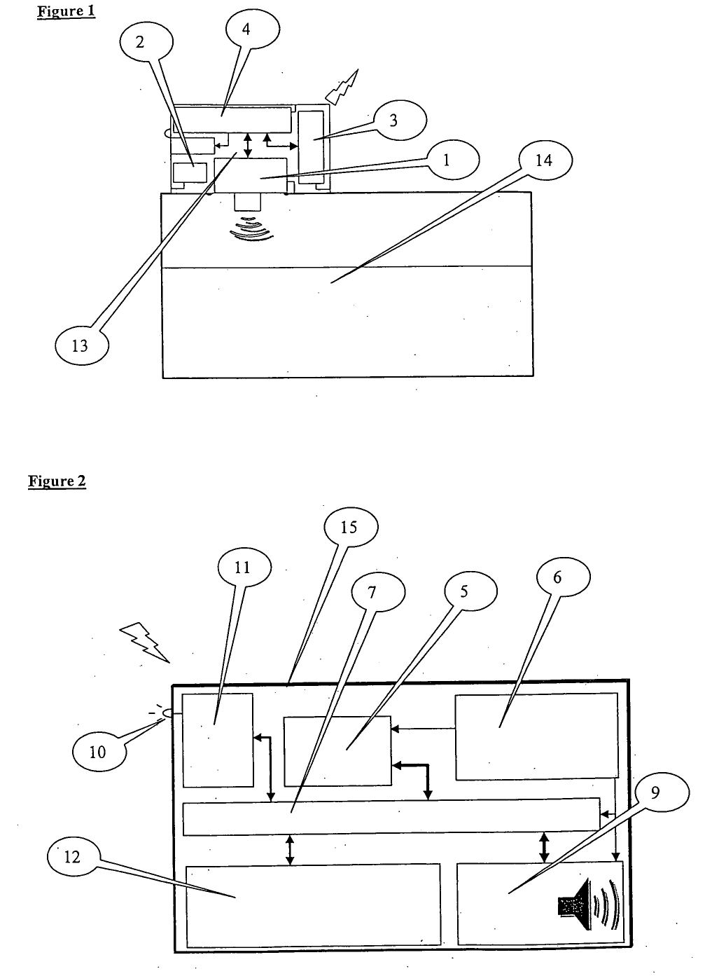

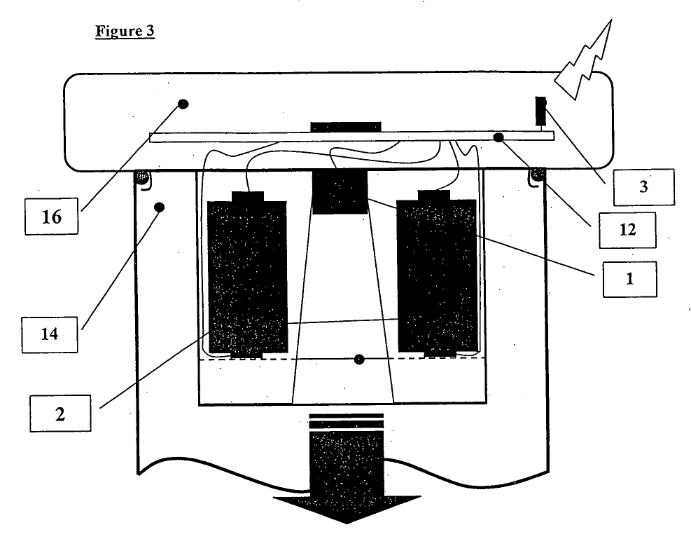

An electronic wireless detection and alarm device allowing monitoring of fluid level in a tank or cistern.

This invention deals with an electronic wireless device permitting detection of a change in the level of a liquid in a tank or cistern.

The goal of the invention is to provide an electronic device capable of detecting any change in the level of any liquid inside of a tank. This device, installed for instance on a truck tank, will immediately alert its owner when the vehicle is stolen or fuel is lost for whatever cause while remaining simple and very easy to install.

A few system are currently available to prevent fuel theft through the tank filler such as mechanically lockable caps which remain relatively ineffective against thieves who unhesitatingly rupture the filler cap to siphon the fuel away without further hindrance.

A more recent scheme consists in securing a mechanical element inside the tank preventing introduction of a hose, thus making siphoning of the fuel virtually impossible. Its effectiveness rests with its novelty, or its “surprise” effect but it is still vulnerable as it can be dismantled and cannot prevent puncturing of the tank to recover the fuel contained therein.

In order to solve all these technical problems the device of the invention includes two electronic modules.

The first is integrated in the filler cap (16), its electronic components being molded into the cap (16). This module is referred to as the monitoring module (13).

The monitoring module (13) is totally autonomous thanks to standard batteries (2), which are also incorporated in the cap. In operation, the module (13) is responsible for monitoring the level of liquid using a telemetry system (1), the signals of which are processed by a microcontroller (4), which in turn periodically transmits towards the second module (15) via an HF transceiver (4) a radio signal including the condition of the module during transmission.

The second module, which is a control module (15) is responsible for triggering the alarms by analyzing the information conveyed by the radio transmission from the monitoring module (13). The module (15) is connected to the electrical power system (6) of the vehicle it is intended to protect, for example to the vehicle's cigarette lighter plug or directly to the battery. The control module (15) features an audible (9) and/or visible (10) alarm system managed by a microcontroller (7) as well as an HF transceiver (5) for communication between the different modules.

Enabling or disabling the surveillance mode of the monitoring module (13) is effected through the control module (15) using the HF transceiver (5). The radio signal from the module (15) serves to enable or disable the so-called “polling” mode of the monitoring module (13).

It is possible for the control module (15) to manage several monitoring modules (13).

Triggering of an alarm by the module (15) will unavoidably happen in case of removal or tearing away of the filler cap or if the fuel level decreases in the tank (14). Moreover, damage to the filler cap (16) or the monitoring module (13) will immediately initiate triggering of the alarm system by the control module (15).

The alarm sounded and/or displayed by the system is intended to alert the owner to the theft attempt and deter thieves.

The user will eventually be able to pick the type of alarm amongst the various possible combinations listed hereinafter via an MMI (11).

High volume alarm using a siren (9); a low volume, discreet alarm using a beeper incorporated in the control module (15), intended for the owner only, and installed near the control module.

LED type alarm (10) incorporated in the control module (15), intended for the owner only and designed exclusively to report an anomaly. Also a discreet alarm.

Remote surveillance (12) allowing the user to connect an off-the-shelf system to the control module (15). The device, sends a call on the user-selected phone number in case something abnormal happens.

1. An electronic detection device allowing monitoring of the level in a tank or cistern (14) featuring a monitoring module (13) comprised of an autonomous, compact and wireless batter-powered telemetry system that transmits an alarm-triggering signal to a control module (15) in case of a forced entry, a theft, or an accidental leak.

2. The device of claim 1 wherein the two modules (13) and (15) communicate wirelessly with each other using a one-way or two-way radio transceiver unit (3) and (5).

3. The device of claim 1 characterized by an ultrasound telemetry system.

4. The device of claim 1 wherein the monitoring module (13) is powered by a battery (2) and controlled by a microcontroller (4), thereby making it autonomous and compact.

5. The device of claim 4 wherein the monitoring module (13) is totally housed inside the filler cap (14), making it autonomous and compact.

6. The device of claim 1 wherein a warning light, in addition to its effect as a deterrent, displays the condition of the module (13).
